(19) United States
(12) Patent Application Publication
(10) Pub. No.: US 2025/0086883 A1
(43) Pub. Date: Mar. 13, 2025

(54) OBJECT VIEWABILITY IN VIRTUAL ENVIRONMENTS

(71) Applicant: GOOGLE LLC, Mountain View, CA (US)

(72) Inventors: Yazan RISHEQ, Mountain View, CA (US); Beril ERKIN, Mountain View, CA (US); Vinay Ananthram KINI, Mountain View, CA (US); Pradeep NAKIREKOMMULA, Mountain View, CA (US); Jimmy LY, Mountain View, CA (US)

(21) Appl. No.: 18/569,291

(22) PCT Filed: Feb. 6, 2023
(86) PCT No.: PCT/US23/12382

§ 371 Date: Dec. 12, 2023

Related U.S. Application Data
(60) Provisional application No. 63/443,171, filed on Feb. 3, 2023.

(51) Int. Cl. G06T 15/40; G06V 10/75; G06V 10/764

(52) U.S. Cl. CPC G06T 15/40; G06V 10/751; G06V 10/764

(57) ABSTRACT

Methods, systems, and apparatus, including computer programs encoded on computer storage media, for determining viewability of an object by a user in a virtual environment, including capturing a two-dimensional projection of the object as presented in the virtual environment, determining that the two-dimensional projection of the object matches a reference version of the object based on a comparison of an average color of features of the reference version of the object and the average color of the features in the two-dimensional projection of the object, and classifying presentation of the object in the virtual environment based on whether the two-dimensional projection of the object matches the reference version of the object.

### CROSS-REFERENCE TO RELATED APPLICATION

This application claims priority to U.S. Provisional Application Ser. No. 63/443,171, filed Feb. 3, 2023, the entirety of which is incorporated herein by reference.

### TECHNICAL FIELD

This specification relates to virtual computing environments.

### BACKGROUND

Virtual environments in gaming environments, metaverse, and multiverses can include content rendered throughout the virtual environment, but that content may not be viewable for various reasons. For example, content rendered in the virtual environment may not be presented until a user adjusts a field of view of the user to a location of the rendered content in the virtual environment. Rendered content in the virtual environment can also be occluded from the user, e.g., by one or more other objects in the virtual environment, preventing the user from viewing the rendered content.

### SUMMARY

This specification describes technologies for determining whether content presented in a computing environment within a field of view of a user is occluded, impaired, or otherwise not considered viewable.

These technologies generally involve an object visibility pipeline to determine whether an object (e.g., publisher content) presented to a user interacting with a computing environment, (e.g., a dynamic gaming environment, two-dimensional, three-dimensional, augmented reality, virtual reality environment), is viewable by the user. Based on the outcome of the object viewability pipeline, the rendered content can be classified as viewable or not viewable (e.g., occluded or otherwise deemed not viewable) in the computing environment.

In general, one innovative aspect of the subject matter described in this specification can be embodied in methods that include the actions of determining that a presentation of the object within the virtual environment meets a set of viewability conditions, capturing a two-dimensional projection of the object as presented in the virtual environment, determining that the two-dimensional projection of the object matches a reference version of the object based on a comparison of an average color of features of the reference version of the object and the average color of the features in the two-dimensional projection of the object, and classifying presentation of the object in the virtual environment based on whether the two-dimensional projection of the object matches the reference version of the object. In response to determining that the two-dimensional projection of the object matches the reference version of the object, classifying the presentation of the object within the virtual environment as a viewable rendering of the object. In response to determining that the two-dimensional projection of the object does not match the reference version of the object, classifying the presentation of the object within the virtual environment as a non-viewable rendering of the object.

Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. In particular, one embodiment includes all the following features in combination. In some implementations, the set of viewability conditions includes validating, from one or more processors, a rendering confirmation for the object within the virtual environment.

In some implementations, the set of viewability conditions includes determining a viewing angle of the object within a field of view of the user in the virtual environment meets a threshold angle criterion with respect to a surface normal of the object in the virtual environment with respect to the field of view of the user.

In some implementations, the set of viewability conditions includes determining that object pixels comprising the object include coordinates coinciding with the field of view of the user within the virtual environment.

In some implementations, the set of viewability conditions includes determining a transparency threshold is met for one or more features of the object within the field of view of the user, e.g., from a perspective of the user. The one or more features of the object can include at least one corner feature of the object and a center feature of the object.

In some implementations, the set of viewability conditions includes validating a dimensionality of the object meets a threshold dimensionality. Validating the dimensionality includes determining a pixel ratio of the object pixels to on-screen pixels meets a threshold value and determining a threshold number of object pixels include onscreen pixels.

In some implementations, the set of viewability conditions includes determining an average luminance of the object meets a threshold luminance. Determining the average luminance of the object meets the threshold luminance can include

calculating an average luminance of pixels including the object, converting the average luminance to a representative value, and comparing the representative value to a threshold luminance value.

In some implementations, classifying presentation of the object in the virtual environment further includes in response to classifying the presentation of the object within the virtual environment as the viewable rendering of the object, incrementing a count of viewability of the object, determining that a number of sequential incrementations of the count of viewability of the object meets a threshold viewability count, and registering the presentation of the object.

In some implementations, classifying presentation of the object in the virtual environment further includes in response to classifying the presentation of the object within the virtual environment as a non-viewable rendering of the object, incrementing a count of non-viewability of the object, determining that a number of sequential incrementations of the count of non-viewability meets a threshold non-viewability count, providing an alert regarding the non-viewability of the object.

In some implementations, determining that the two-dimensional projection of the object matches the reference version of the object includes computing a hash of the two-dimensional projection, and comparing the hash of the two-dimensional projection to the hash of the reference version of the object. Computing the hash of the two-dimensional projection and of the reference version of the object can include computing an average hash. Computing the average hash can include computing an average color value of at least a portion of the two-dimensional projection, encoding each pixel of the two-dimensional projection based on whether a color value of the pixel is at least the average color value, creating a bit string based on the encoded pixels, and converting the bit string to a hex value.

In some implementations, determining that the two-dimensional projection of the object matches a reference version of the object includes determining a difference between the hex value and a reference hex value representing the reference version of the object.

In some implementations, determining that the two-dimensional projection of the object matches a reference version of the object includes identifying locations of a set of edges in the reference version of the object, searching for the locations of the set of edges in the two-dimensional projection, and comparing an average color of pixels of the locations of the edges in the two-dimensional projection to the average color of pixels of the locations of the edges in the reference version of the object.

The subject matter described in this specification can be implemented so as to realize one or more of the following advantages. An object viewability pipeline including a series of sequential checks for object viewability, where each viewability check is validated before a next viewability check can be performed by the system, can reduce the processing resources required to determine viewability. For example, in the case where a viewability condition is not met, the system may not proceed to a next validation step of the set of viewability conditions, thereby reducing a computational requirement for validating the object viewability. The object viewability pipeline can be used as a lightweight object viewability process that can be performed by an edge device with compute and/or power limitations, e.g., on a user device, such as a mobile device that is battery operated. In these situations, reducing the processing resources required to make a viewability determination reduces the battery consumption, and therefore, extends the amount of time that the device can operate off a single battery charge. Furthermore, because the user device has limited processing power, reducing the processing resources required to make a viewability determination prevents negative effects of diverting processing resources from rendering and presenting the virtual three-dimensional environment. For example, using fewer resource intensive viewability determinations, such as those discussed herein, help prevent game glitching or lagging, both of which can make the game unplayable. Some of the lightweight viewability determination processes include a hash technique or a feature detection technique (e.g., an edge detection technique), which are discussed in detail below. These two techniques enable viewability determinations at the user device without interrupting, or negatively affecting, rendering, or presenting the three-dimensional environment at the user device.

Validating object viewability can offer critical feedback, e.g., presentation registration, to content publishers of the effectiveness of the content embedded in the virtual environments. For example, presentations of embedded content in a three-dimensional virtual gaming or experience environment can be more efficiently and accurately validated. The object viewability pipeline can be integrated into a dynamic gaming environment, e.g., a three-dimensional VR/AR experience, without substantially impacting the gaming environment. A field of view of the user may be constantly changing in the dynamic gaming environment, such that content may move in and out of the field of view of the user, and where the pipeline can more accurately track presentation of publisher content by the user. Additionally, the object viewability pipeline includes a check to determine that characteristics of the presented object are maintained in the environment, thus enabling not just content publishers to validate an accurate content presentation, but additionally can be used by developers to improve the environment during development cycles.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a block diagram of an example operating environment in which content is distributed to client devices.

FIG. 1B depicts a block diagram of an example client computing system that is configured to render a virtual environment showing third-party content specified by a content distribution system.

FIG. 2 is a block diagram of an example computing environment in which content is presented to a user on a client device.

FIG. 3 is a flow diagram of an example object viewability pipeline.

FIG. 4 is a flow diagram of an example process of the object viewability pipeline.

FIG. 5 is a block diagram of an example computing environment in which content is presented to a user on a client device.

FIG. 6 is a block diagram of an example computing environment in which content is presented to a user on a client device.

FIG. 7 is a block diagram of an example generic computing system.

Like reference numbers and designations in the various drawings indicate like elements.

### DETAILED DESCRIPTION

At times, content can be presented to a user of a virtual or augmented reality environment (e.g., a two-dimensional or three-dimensional environment) in a non-disruptive format without breaking an immersive experience of the user while providing means of presenting content (e.g., third-party publisher content) to the user within the computing environment. Presented content can be, for example, a two-dimensional or three-dimensional object rendered within the computing environment. A field of view of a user within the computing environment can change over time, e.g., as a user moves relative to the computing environment. Additionally, the computing environment can include one or more other objects rendered within the computing environment within the field of view of the user, potentially occluding (e.g., partially occluding) the presented content. A viewability of the content by the user within a field of view of the user can be determined using an object viewability pipeline that can determine a viewability of the presented content by the user over a measured period of time.

In some embodiments, tracking viewability of presented content over a period of time triggers classification of the presented content within the computing environment as perceivable by the user, which can be referred to as a valid presentation, e.g., a valid impression. Further metrics related to the presented content, e.g., content exposure time, interaction by the user with the content, etc., can additionally be tracked for a presentation of the presented content.

As discussed in more detail below, whether content presentation is classified as perceivable by the user can depend on “unscripted” actions within the virtual environment (e.g., two-dimensional environment, three-dimensional environment, or another type of immersive experience). For example, if a user crashes a car in a racing game, and the smoke from the fire is making it difficult to perceive a set of content presented on a wall of a building (or a billboard in the three-dimensional environment), the set of content may be deemed imperceivable even though the smoke is not completely opaque, and the smoke does not have attributes (e.g., physical colliders or other attributes) defined that enable the smoke to be directly identified as interfering with the visibility of an object). Because of the dynamic nature of three-dimensional environments (e.g., dynamically changing in response to users' actions), and the possibility that scene objects that do not have detectable attributes defined can severely impair the perceivability of a set of content, techniques can be used to determine the level of degradation of the presentation of the set of content by scene objects (e.g., smoke, clouds, ghosts, etc.). As discussed in more detail below; these techniques can include one or more of a hash technique or a feature detection/matching technique, e.g., edge detection, which can be used to quantify the level of degradation of the presentation of the set of content relative to a reference version of the set of content. Note that the techniques discussed herein are described for use in a three-dimensional environment, but that these or similar techniques can also be implemented in a two-dimensional environment.

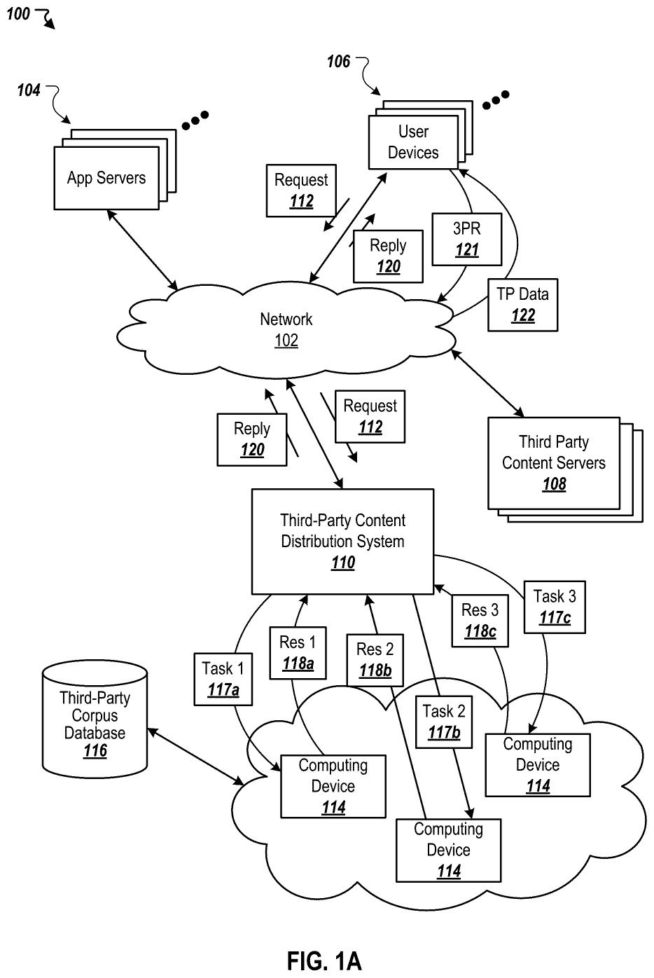

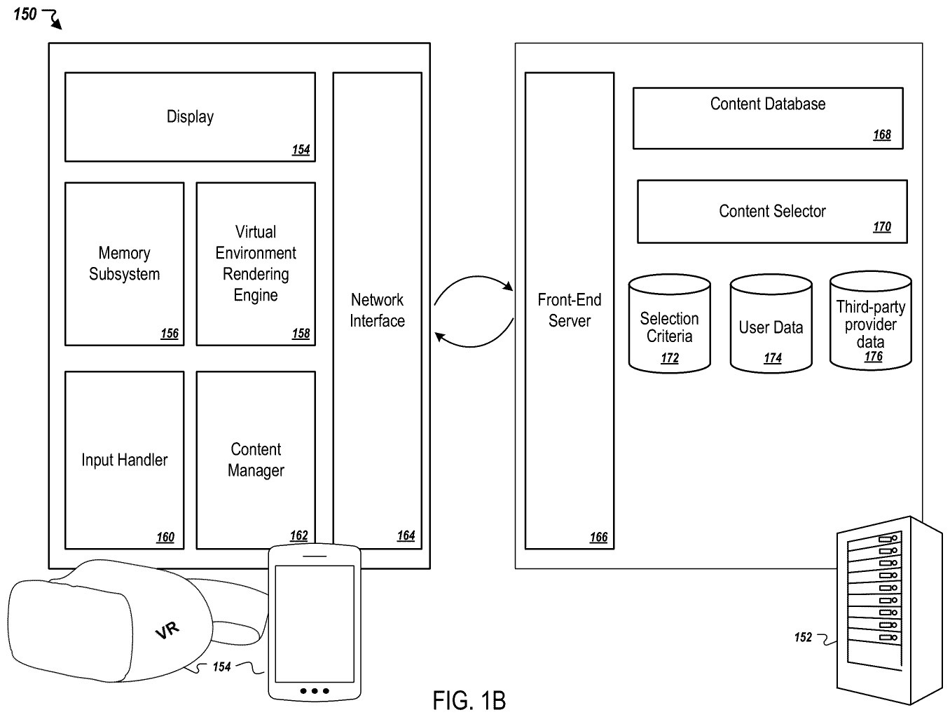

FIG. 1A is a block diagram of an example framework 100 in which third-party content is distributed for presentation with virtual two-dimensional or three-dimensional objects in a virtual environment, such as a virtual reality environment. The virtual environment can be a two-dimensional (2D) environment, a three-dimensional (3D) environment, or another type of immersive interactive environment including augmented and virtual reality environments. The example framework 100 includes a network 102, such as a local area network (LAN), a wide area network (WAN), the Internet, or a combination thereof. The network 102 connects application servers 104, user devices 106, third-party content servers 108, and a third-party content distribution system 110 (also referred to as a content distribution system). The example framework 100 may include many different application servers 104, user devices 106, and third-party content servers 108.

A user device 106 is an electronic device that is capable of requesting and receiving resources (e.g., virtual environment applications) over the network 102. Example user devices 106 include personal computers, mobile communication devices, and other devices that can send and receive data over the network 102. A user device 106 typically includes a user application, such as a web browser, to facilitate the sending and receiving of data over the network 102, but native applications executed by the user device 106 can also facilitate the sending and receiving of data over the network 102.

A resource (e.g., a virtual environment application or a definition file for a virtual environment) is a resource that is directed to rendering virtual environments that can include text, images, video, or other media types, on a user device 106. Examples of resources include virtual reality applications, video games, mixed reality applications, augmented reality applications, and definitions for virtual environments that can be displayed in any of these types of applications. A resource may include data that defines one or more virtual environments and virtual objects within the virtual environments. A resource can include data that defines virtual objects, e.g., two-dimensional or three-dimensional objects, for presentation within the virtual environments. Resources can be provided to user devices 106 by application servers 104. For example, the application servers 104 can include servers that host publisher websites. In this example, the user device 106 can initiate a request for a given resource, and the application server 104 that hosts the given resource can respond to the request by transmitting the resource to the user device 106. In some implementations, the application server can provide one or more definition files to the user device 106. A definition file includes data that represents a virtual environment that can be processed by an application installed on the user device 106 to render the virtual environment.

In some situations, a given resource can include a third-party tag or third-party script that references the third-party content distribution system 110. In these situations, the third-party tag or third-party script is executed by the user device 106 when the given resource is processed by the user device 106. Execution of the third-party tag or third-party script configures the user device 106 to generate a request 112 for third-party content (e.g., content that is not defined within the resource, but obtained from a third party and inserted into the resource), which is transmitted over the network 102 to the third-party content distribution system 110. For example, the third-party tag or third-party script can enable the user device 106 to generate a packetized data request including a header and payload data. The request 112 can include data such as a name (or network location) of a server from which the third-party content is being requested, a name (or network location) of the requesting device (e.g., the user device 106), and/or information that the third-party content distribution system 110 can use to select third-party content provided in response to the request. The request 112 is transmitted, by the user device 106, over the network 102 (e.g., a telecommunications network) to a server of the third-party content distribution system 110.

The request 112 can include data specifying the resource, data specifying characteristics of the virtual object (e.g., a two-dimensional or three-dimensional virtual object) on which third-party content is to be presented, and data specifying characteristics of the virtual environment in which the virtual object occurs. For example, data specifying a shape or geometry of the virtual object on which the third-party content will be presented (e.g., a two-dimensional or three-dimensional virtual object), a size of the virtual object (e.g., a length, width, height, and/or volume), a location of the virtual object in the virtual environment, a number of eligible surfaces on the virtual object that can receive third-party content, descriptive keywords associated with the virtual environment, and/or media types that are eligible for presentation on the virtual object can be provided to the content distribution system 110.

Requests 112 can also include data related to other information, such as information that the user has provided, geographic information indicating a state or region from which the request was submitted, or other information that provides context for the environment in which the third-party content will be displayed. Data specifying characteristics of the user device 106 can also be provided in the request 112, such as information that identifies a model of the user device 106, selection capabilities of the device 106 (e.g., whether hand-based controls are available to select virtual objects, whether a control is available on the headset itself that a user can tap to select items rendered in a virtual reality environment), a configuration of the user device 106, a type of an electronic display (e.g., a touchscreen of a smartphone, tablet, or gaming device, or a head-mounted display for a VR device 106). Requests 112 can be transmitted, for example, over a packetized network, and the requests 112 themselves can be formatted as packetized data having a header and payload data. The header can specify a destination of the packet and the payload data can include any of the information discussed above.

The third-party content distribution system 110 selects third-party content that will be presented on or near a virtual object in a virtual environment, in response to receiving the request 112 and/or using information included in the request 112.

In some implementations, the distribution parameters (e.g., selection criteria) for a particular third-party content can include distribution keywords that must be matched (e.g., by resources or terms specified in the request 112) in order for the third-party content to be eligible for presentation. The distribution parameters can also require that the request 112 include information specifying a particular geographic region (e.g., country or state) and/or information specifying that the request 112 originated at a particular type of user device 106 in order for the third-party content to be eligible for presentation. The distribution parameters can also specify a bid and/or budget for distributing the particular third-party content.

The identification of the eligible third-party content can be segmented into multiple tasks 117a-117c that are then assigned among computing devices within the set of multiple computing devices 114. For example, different computing devices 114 in the set can each analyze a different portion of the third-party corpus database 116 to identify various third-party content having distribution parameters that match information included in the request 112. In some implementations, each given computing device 114 in the set can analyze a different data dimension (or set of dimensions) and pass results (Res 1-Res 3) 118a-118c of the analysis back to the third-party content distribution system 110. For example, the results 118a-118c provided by each of the computing devices in the set may identify a subset of third-party content that are eligible for distribution in response to the request and/or a subset of the third-party content that have certain distribution parameters or attributes.

The third-party content distribution system 110 aggregates the results 118a-118c received from the set of multiple computing devices 114 and uses information associated with the aggregated results to select one or more instances of third-party content that will be provided in response to the request 112. For example, the third-party content distribution system 110 can select a set of winning third-party content based on the outcome of one or more content evaluation processes, as discussed in further detail below. In turn, the third-party content distribution system 110 can generate and transmit, over the network 102, reply data 120 (e.g., digital data representing a reply) that enable the user device 106 to integrate the set of winning third-party content into the virtual environment, e.g., for presentation on an eligible virtual object in the virtual environment.

In some implementations, the user device 106 executes instructions included in the reply data 120, which configures and enables the user device 106 to obtain the set of winning third-party content from one or more third-party content servers. For example, the instructions in the reply data 120 can include a network location (e.g., a Uniform Resource Locator (URL)) and a script that causes the user device 106 to transmit a third-party request (3PR) 121 to the third-party content server 108 to obtain a given winning third-party content from the third-party content server 108. In response to the request, the third-party content server 108 will transmit, to the user device 106, third-party data (TP Data) 122 that causes the given winning third-party content to be incorporated into the virtual environment and presented at the user device 106.

FIG. 1B depicts a block diagram of an example client computing system 150 that is configured to render a virtual environment, e.g., a two-dimensional or three-dimensional virtual environment, showing third-party content specified by a content distribution system 152. In some implementations, the client computing system 150 is a user device, e.g., user device 106 from FIG. 1. The content distribution system 152 can be configured as a third-party content distribution system 110 from FIG. 1, the third-party content servers 108 from FIG. 1, or can include aspects of both servers 108 and system 110. The content distribution system 152 can generally be implemented as a system of one or more computers in one or more locations. The client computing system 150) communicates with the content distribution system 152 over a network (e.g., the Internet, a local area network, a wireless broadband network). Although not shown in FIG. 1B, the client computing system 150 can communicate with other systems in addition to content distribution system 152 for various purposes. For example, the client computing system 150 may communicate with servers for an online application store or developer servers to obtain virtual reality, augmented reality, and/or mixed reality applications that enable the system 150 to render a virtual environment. Likewise, the client computing system 152 may communicate with the servers for an online application store or developer servers to obtain definition files for a virtual environment, e.g., an immersive virtual reality game.

The client computing system 150 can be any of a variety of computing systems and/or gaming devices that are configured and enabled to render virtual environments with incorporated third-party content. In some examples, the client computing system 150 is configured to present a virtual reality type of virtual environment, which a user views via a head-mounted display. In other examples, the client computing system 150 is configured to present other types of virtual environments, such as an augmented reality environment, a mixed reality environment, or an environment on a conventional two-dimensional screen. The system 150 may be integrated into one device or may include multiple, separately connected components in one or more locations. In some implementations, the client computing system 150 includes a display 154, a memory subsystem 156, a virtual environment rendering engine 158, an input handler 160, a content manager 162, and a network interface 164.

The display 154 is an electronic display that is configured to visually display the virtual environment to a user. The display 154 can take various forms for different types of systems. For example, a display 154 can include a head-mounted display, a display of a mobile device, tablet, television, or gaming console, or another display through which the user can view the virtual environment. As depicted in FIG. 1B, a display 154 can be, for example, a head-mounted display or a display (e.g., a screen) of a mobile device. For example, in a virtual reality system, the display 154 may be a head-mounted display in which the viewing screen of the display 154 is fixed in a position several inches in front of a user's eyes. In a VR system, the display 154 may provide a stereoscopic presentation of a virtual environment, e.g., a three-dimensional virtual environment. When the user views the stereo presentation of the virtual environment through a set of lenses, the virtual environment can appear to have depth so the user feels as if he or she is immersed in the virtual environment. In some implementations, the screen is an integral component of the head-mounted display. In other implementations, a smartphone or other mobile unit is removably fixed to a head unit to form a head-mounted display that uses the screen of the mobile unit as the screen of the head-mounted display. The display 154 may be, for example, a liquid-crystal display (LCD), an organic light-emitting diode display (OLED), or an active matrix OLED (AMOLED) display.

The memory subsystem 156 includes one or more storage devices storing data that characterizes a virtual environment. A virtual environment is a virtual environment that is capable of being rendered in three dimensions. Examples of virtual environments include 3D gaming and video environments (e.g., live or recorded event streams such as 3D concert or athletic event streams). In some cases, a user of the client computing system 150 can explore a virtual environment by moving his or her head to look around the environment (e.g., in a virtual reality system), by moving around the environment, by manipulating objects in the environment, or a combination of these. Other components of the client computing system 150 may access the memory subsystem 156 to read, write, or delete data from the storage devices.

In some implementations, the data stored by the memory subsystem 156 that characterizes the virtual environment includes declarations for third-party content. Third-party content, e.g., virtual objects, can be declared for a virtual environment using any of a variety of suitable programming techniques. In some implementations, developers can insert a tag, a script, or executable code to the definition file(s) for a virtual environment that, when executed, instantiates an object, e.g., a two-dimensional or three-dimensional object, in the virtual environment in accordance with any parameters specified therein.

The virtual environment rendering engine 158 is a subsystem of the client computing system 150 that is configured to read the definition of a virtual environment from the memory subsystem 156 and to render the virtual environment for presentation to a user via the display 154 and, optionally, using one or more additional peripheral output devices (e.g., speakers, hand-controllers, haptic feedback devices). The rendering engine 158 can include one or more data processing apparatuses (e.g., processors) that are configured and enabled to perform the operations described herein. The data processing apparatuses may be dedicated to the rendering engine 158 or may be at least partially shared with other components of the client computing system 150. In some implementations, the rendering engine 158 includes one or more graphics processing units (GPUs) that process the virtual environment definition files and render a presentation of the environment. For example, the rendering engine 158 for a virtual reality system may process one or more definition files for a virtual environment to generate a stereoscopic display of the virtual environment which, when viewed by a user through specially configured lenses, provides an immersive 3D experience to the user.

The input handler 160 is a subsystem of the client computing system 150 that is configured to monitor one or more input channels for user inputs received while the virtual environment is rendered for a user. The input handler 160 can include one or more data processing apparatuses (e.g., processors) that are configured and enabled to perform the operations described herein. The input handler 160 may detect various types of user inputs depending on the particular configuration of the client computing system 150. For example, a basic virtual reality (VR) system may detect user inputs based on signals from one or more orientation and motion sensors in a head-mounted display unit. The orientation and motion sensors may include one or more accelerometers, compasses, gyroscopes, magnetometers, or a combination of such sensors. The orientation and motion sensors can generate signals indicative of the direction of a user's gaze within the 3D VR environment in real time, and these signals can be interpreted by the input handler 160 to track the direction of the user's gaze in real time. Tracking the direction of the user's gaze in real time can be used, for example, to determine a field of view of the user within the virtual environment and define a viewport of a viewable portion of the virtual environment by the user. Additionally, the client computing system 150 may include one or more buttons or switches, e.g., on a hand-based controller or on the head-mounted display, that can be actuated by a user to provide input to the system 150. More advanced VR systems may provide additional user input channels such as motion tracking sensors located external to the head-mounted display which track movements of fiducials on the head-mounted display. The input handler 160 can interpret signals from the external motion sensors to determine the user's motion in six degrees of freedom, e.g., including rotations and translations.

In some implementations, the system 150 includes a content manager 162 to monitor the provided third-party content within the virtual environment. The content manager 162 can be a subsystem of the system 150 that manages the content (e.g., virtual objects) that appear in the virtual environment. The content manager 162 can be implemented as one or more data processing apparatus (e.g., processors) in one or more locations that are programmed to perform the operations described herein. The data processing apparatus can be dedicated to the content manager 162 or can be shared with one or more other components of the system 150. For example, the data processing apparatus can include a central processing unit (CPU) and/or a graphics processing unit (GPU) of the client device.

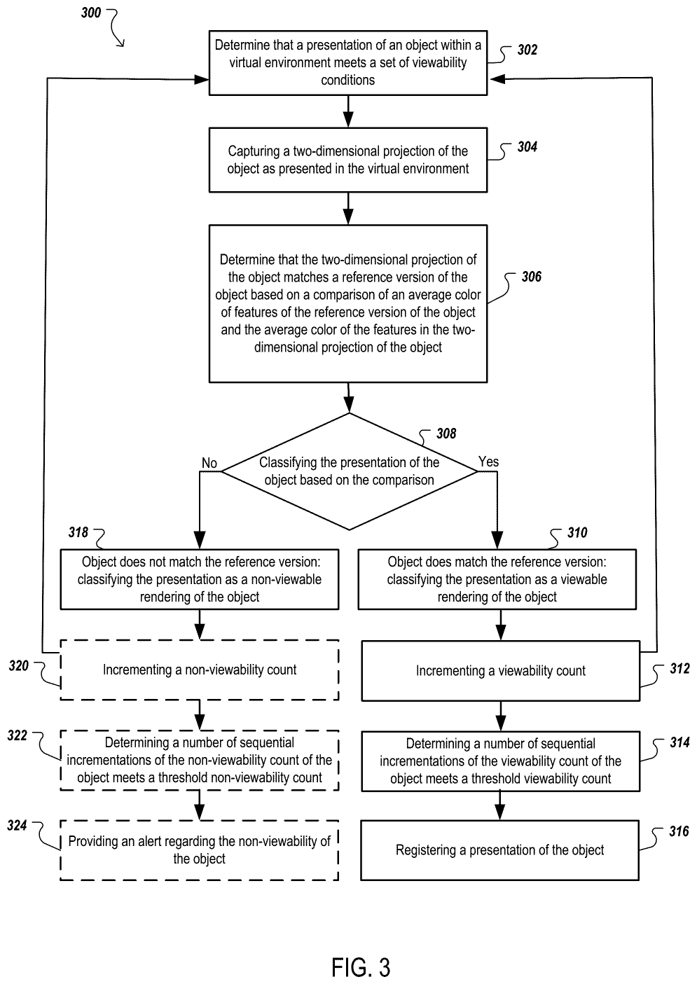

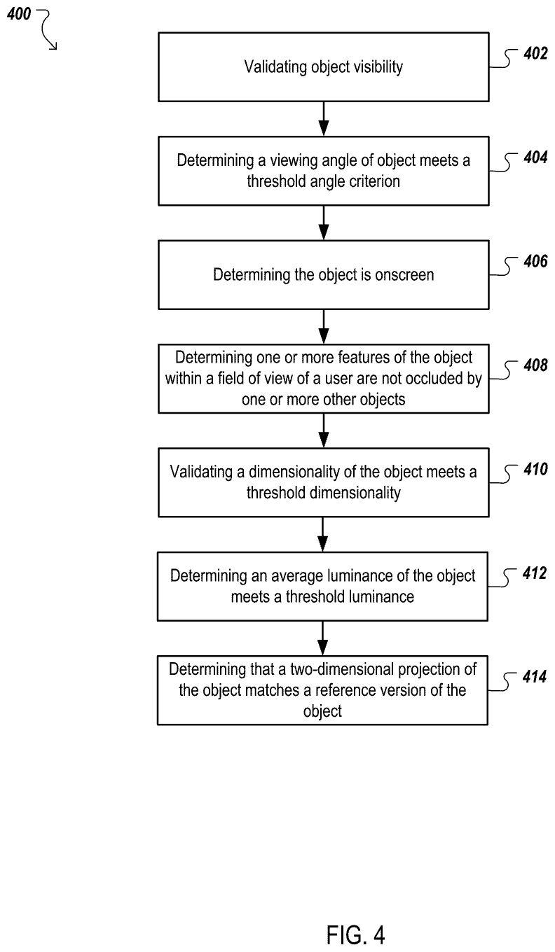

In some implementations, the content manager 162 is configured to receive information from the input handler 160 related to a current field of view of the user through a display 154 and determine that a presentation of an object within the virtual environment meets viewability condition(s), e.g., as described in further detail with reference to FIGS. 3 and 4. The content manager 162 can further be configured to classify the presentation of the object, e.g., as a viewable rendering of the object or as a non-viewable rendering of the object, and provide to the content distribution system 152, information related to the classified presentation. For example, the content manager 162 can provide to the content distribution system 152 a confirmation of user interaction with the presentation of the object.

The client computing system 150 transmits messages to, and receives messages from, the content distribution system 152. The content distribution system 152 may be implemented as one or more computers (e.g., data processing apparatus) in one or more locations. In general, the content distribution system 152 is configured to select third-party content to display within a virtual environment at the client computing system 150. The content distribution system 152 makes selected third-party content available to the client computing system 150, e.g., by transmitting the content to the client system 150 over a network such as the Internet or a local area network. The content distribution system 152 can include one or more of a front-end server 166, a third-party content database 168, a content selector 170, a data repository that stores selection criteria 172, a second data repository 174 that stores end-user account and profile information, and a third data repository 176 that stores third-party content provider account and profile information.

The front-end server 166 is configured to receive and transmit information from the content distribution system 150. The front-end server 166 provides an interface for the content distribution system 152 to interact with other computers over a communications network (e.g., the Internet). For example, FIG. 1B shows the front-end server 166 in communication with the client computing system 150. The front-end server 166 receives requests for third-party content, performs initial processing of received requests, forwards information derived from requests to other appropriate components of the content distribution system 152, and transmits responses that the system 150 generates in response to requests. In some implementations, the front-end server 166 includes a network interface that provides an interconnection between the content distribution system 152 and one or more networks, which may be either public (e.g., the Internet) or private (e.g., a local area network). The network interface may include one or more network interface cards, which for example, are configured to transmit and receive data over a packetized network.

The content database 168 is a database, or other type of data repository, that maintains an index of third-party content. The third-party content itself may also be stored by the content database 168, may be stored by the content distribution system 152 but externally of the content database 168, or may be stored at one or more other systems outside of the content distribution system 152. In general, the content database 168 identifies the set of third-party content that is available for the content distribution system 152 to return to client systems in response to requests for third-party content, e.g., for presentation within the virtual environment.

Content selector 170 is the component of the content distribution system 152 that selects winning third-party content for a request, e.g., content to display within the virtual environment. To determine winning third-party content, the content selector 170 evaluates eligible third-party content items with respect to various selection criteria 172 associated with a request. The selection criteria may include keywords or other context data specified in a request. In some implementations, the selection criteria include profile data that indicates interests and preferences of the end user of the client system 150, profile data of third-party content providers, and information about the virtual environment in which the virtual object is presented. The selection criteria 172 can further include bids set forth by third-party content providers that indicate a price the third-party content provider is willing to pay for the provider's third-party content to be selected and returned for display on or by a virtual object in response to a request. The content selector 170 applies the selection criteria 172 to a given third-party content request and performs the evaluation process to select winning third-party content.

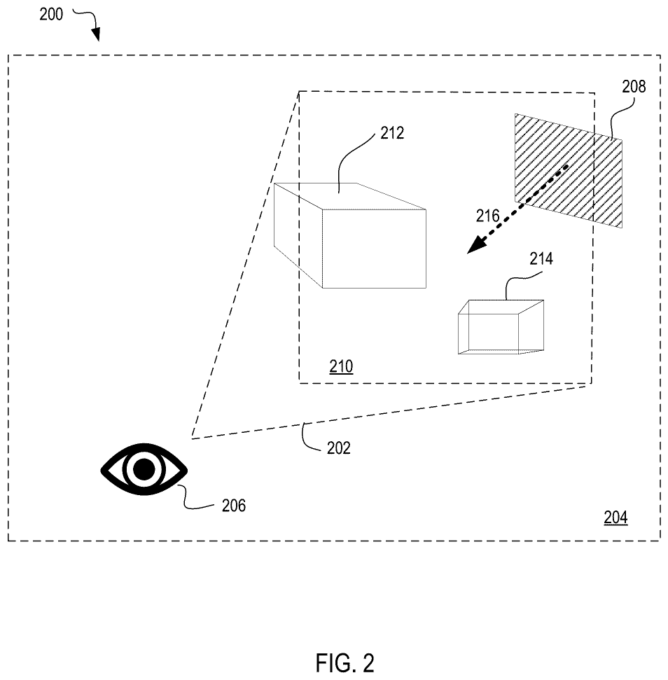

FIG. 2 is an example operating environment 200 for object presentation within a virtual environment. A client computing system, e.g., client computing system 150, can render a virtual environment on a display, e.g., display 154. The virtual environment may be rendered by a rendering engine, e.g., virtual environment rendering engine 158 of the client computing system 150. The virtual environment can include third-party content, e.g., third-party content provided by a content selector 170, that can be rendered within the virtual environment as a two-dimensional or three-dimensional object. As used here, the field of view 202 within the virtual environment 204 is defined from a viewing location of the user 206 within the virtual environment 204. At times, the field of view 202 of the user 206 of the virtual environment 204 can change as the user moves with respect to the virtual environment. For example, as the user shifts their gaze within the virtual environment or moves their virtual representation within the virtual environment. In some implementations, as the user's field of view shifts within the virtual environment, an object 208 within the virtual environment 204, e.g., the publisher content, can move out of the field of view 202 of the user. In other words, a viewport 210 corresponding to what is onscreen for the user 206 can move with respect to the object 208 such that at least a portion of the object 208 can be outside the viewport 210.

In some implementations, one or more other objects, e.g., objects 212, 214, are rendered within the field of view of the user 206 in the virtual environment 204. The one or more other objects 212, 214 can be located within the virtual environment such that at least one of the objects 212, 214 at least partially occlude a view of the object 208 by the user 206. For example, an object 212 occludes a portion of object 208 from view by the user 206 within the viewport 210.

In some implementations, the system, e.g., content manager 162 of client computing system 150, can determine whether an object rendered within the virtual environment 204, meets a viewability condition.

FIG. 3 is a flowchart of an example process 300 for determining viewability of an object by a user in a virtual environment. For convenience, the process 300 will be described as being performed by a system of one or more computers, located in one or more locations, and programmed appropriately in accordance with this specification. For example, the processes described with reference to FIG. 3 can be performed by a client computing system 150.

At 302, the system determines that a presentation of the object within the virtual environment meets a set of viewability conditions. The set of viewability conditions can include one or more checks by the system of the viewability of the object within the field of the view of the user (e.g., in the viewport) within the virtual environment. In some implementations, the set of viewability conditions can include a sequentially ordered set of checks, where each viewability check is required by a set of rules to be validated before a next viewability check can be performed by the system. In the case where a viewability condition is not met, the system may not proceed to a next validation step of the set of viewability conditions, thereby saving processing resources that would otherwise be allocated to perform further viewability analysis. For example, the system can select to terminate the process of determining that the presentation of the object meets the set of viewability conditions for each of the remaining viewability conditions of the set of viewability conditions.

In some implementations, the sequence of validations of the set of viewability conditions can be ordered such that a computational requirement, e.g., computational complexity, resource usage, power requirement, duration to complete the computation, etc., of each validation step is in increasing order. In other words, a least computationally-intensive viewability condition can be validated before a more computationally intensive viewability condition. Arranging a sequence of checks of the set of viewability conditions with increasing computational complexity can reduce a computational requirement of performing the set of viewability conditions, particularly where the viewability analysis is terminated based on a determination, early in the sequence, that the object is not viewable (e.g., occluded or otherwise deemed not viewable). In other words, if a low computational complexity viewability condition indicates that the object is not viewable, there is no need to perform the viewability condition having a higher level of computational complexity.

At 304, the system captures a two-dimensional projection of the object as presented in the virtual environment. Capturing a two-dimensional projection can include applying a projective transform, e.g., using homography, on the object in the virtual environment. The two-dimensional projection can be resized to match dimensions of the reference version of the object. For example, assume that the reference version of the object is an 8×8 version of the object. In this example, the two-dimensional projection can be scaled down to an 8×8 version to perform the analysis.

At 306, the system determines that the two-dimensional projection of the object matches a reference version of the object based on a comparison of an average color of features of the reference version of the object and the average color of the features in the two-dimensional projection of the object. In some implementations, determining a match between the two-dimensional projection of the object and the reference version of the average includes determining that the two-dimensional projection of the object has less than a specified (e.g., threshold) difference between the average color of the features of the two-dimensional projection of the object and the reference version of the object.

In some implementations, the system determines a match between the two-dimensional projection of the object and the reference version of the object by computing an average hash of the two-dimensional projection and an average hash of the reference object and comparing the average hash to the two-dimensional projection of the object to an average hash of the reference version of the object. The system can compute the average hash of the two-dimensional projection of the object by computing an average color value of pixels included in at least a portion of the two-dimensional projection of the object.

In some implementations, when an object, such as an image and/or advertisement, is presented in a virtual environment, the average hash operation can be performed on the area of the virtual environment that is occupied by the content and within the field of view presented to the user. The average hash operation can be performed on the 2D representation. The output of the average hash operation can be an actual hash value representing the presentation of the advertisement to the user in the virtual environment.

As part of the average hash operation, each of the pixels included in at least a portion of the two-dimensional projection is encoded based on whether a color value of the pixel is at least the average color value. More specifically, if the color value of a pixel is equal to or greater than the average color of the evaluated portion, the pixel is encoded with a “1”, and if not, the pixel is encoded with a “0”. In some implementations, the hashed image is converted to grayscale before the encoding, where the mean grayscale pixel value is calculated using the grayscale values of all the pixels in the portion of the two-dimensional projection of the image being evaluated. The system creates a bit string based on the encoded pixels and converts the bit string into a hex value.

Similarly, the system can compute an average color value of the pixels included in the reference version of the object. Each of the pixels included in the reference version of the object can be encoded based on whether a color value of the pixel is at least the average color value, and the system can create a bit string based on the encoded pixels and convert the bit string into a hex value. The system can determine that the two-dimensional projection of the object matches the reference version of the object by determining a difference between the hex value corresponding to the two-dimensional projection of the object and a hex value corresponding to the reference version of the object. The match can be validated based on the difference between the hex values being less than a threshold difference value. For example, if the reference hash value is hex B98C0, and the actual hash value is hex B98B0, then the average hash analysis outputs a difference of hex 10 (i.e., B98C0-B98B0)=10). This difference between the actual hash value and reference hash value is compared to a predetermined threshold value to arrive at a visibility determination. For example, if the difference is greater than the threshold, the object is classified as not visible/perceivable, but if the difference is less than the threshold, the object is classified as visible/perceivable.

In some implementations, the system determines that the two-dimensional projection of the object matches the reference version of the object by identifying locations of a set of features in the reference version of the object. The features can include, for example, edges and/or corners of the object. For example, the system determines that the two-dimensional projection of the object matches the reference version of the object by identifying locations of a set of edges and/or corners in the reference version of the object. Features of the object can also include, for example, visual differentiators such as text, transitions between light/dark colors, transitions between distinct colors, or other visually distinct features of the object.

In some implementations, determining visibility of an object can depend on how many of the features in the reference object are also found in the set of features that are detected in the actual object as presented in the virtual environment. For example, if there are 15 reference corners in the original version of the content, the viewability of the content as presented in the computing environment can be based on how many of those reference corners/edges are detected in the presentation of the content that is within the field of view presented to the user. If only 5 of the reference corners/edges are found in detected actual corners, then the corner detection analysis outputs a difference of 10 (i.e., 15-5). This difference between the actual corners and reference corners is compared to a predetermined threshold value to arrive at a visibility determination. For example, if the difference is greater than the threshold, the object is classified as not visible, but if the difference is less than the threshold, the object is classified as visible.

The system can search for the locations of the set of features, e.g., edges/corners, in the two-dimensional projection of the object. For example, Harris Corner Detection can be used to search for and identify features of the object. In some implementations, the system can convert the image to grayscale and apply filtering to smooth the noise of the image. The system can use a Sobel Operator to find x and y gradient values for each pixel in the image and consider an N×N (e.g., 3×3, 4×4, etc.) window surrounding each pixel to compute a characteristic of the corner/edge. The computed characteristics of the corner/edge can be a corner strength function, e.g., the Harris value. Pixels having a Harris value greater than a specified threshold value can be confidently identified as corners/edges of the object.

In some implementations, the system can search for a threshold (e.g., a sufficient) subset of the edges of the reference version of the object in the two-dimensional projection. To ensure that the edges detected in the actual presentation of the object are the same edges detected in the reference version of the object, the system can compare the average color of pixels of the locations of the edges in the two-dimensional projection to the average color of pixels of the locations of the edges in the reference version of the object. A match can be validated based on a comparison between the average color of corresponding pixels from the two-dimensional projection and the reference object with respect to a threshold value. For example, a representation of a difference between the average color of corresponding pixels from the two-dimensional projection and the reference object is computed and an empirically determined threshold is applied to the computed difference to determine a valid match. In some implementations, other visual features identified near the reference edges can be used to differentiate between the various reference corners and/or ensure that the actual edges detected in the actual presentation of the object correspond to the reference corners.

At 308, the system classifies the presentation of the object in the virtual environment based on whether the two-dimensional projection of the object matches the reference version of the object. In some implementations, the system classifies the presentation of the object as viewable (310). The system increments a viewability count for the object (312). The system can repeat the processes described with respect to 302-308. For example, the system can continue to check the viewability of the object according to 302-308 periodically, for a duration. The duration of the periodic checks can be, for example, about 1 second. During the duration of the periodic checks of viewability of the object, the system can determine that the object continues to meet the viewability conditions and is classified as viewable. In some implementations, the system determines that a number of sequential incrementations of the viewability count meets a threshold viewability count (314). When the system determines that the number of sequential incrementations meets the threshold viewability count, the system can then register a presentation of the object (316). Registering the presentation of the object can include providing a confirmation to the publisher of the object of the presentation.

In some implementations, the system classifies the presentation of the object within the virtual environment as a non-viewable rendering of the object (318). In some implementations, the system determines that a number of sequential incrementations of the non-viewability counts meets a threshold non-viewability count (320). The system can iterate the processes described with reference to 302-308, periodically, e.g., multiple times per second, where each non-viewability count is incremented when the system classifies the object as non-viewable. In some implementations, the system determines that a number of counts of the non-viewability count meets a threshold non-viewability count (322). For example, the number can be sequential incrementations of non-viewability counts. In another example, the counts of the non-viewability can be non-sequential incrementations, e.g., a cumulative non-viewability count which can be measured over a duration. In some implementations, when the count of non-viewability meets a threshold non-viewability count, the system can provide an alert regarding the non-viewability of the object (324). In some implementations, the alert can be provided to the gaming engine to unload the object. For example, when the system determines that the object is classified as non-viewable a threshold number of times, the system can provide an alert to exchange the object for another, different object.

In some implementations, the set of viewability conditions include a series of checks for viewability of the object within the virtual environment by the user, (e.g., as described with reference to 302, FIG. 3). The set of viewability conditions can include a sequentially ordered set of checks, where each viewability check must be validated before a next viewability check can be performed by the system. In the case where a viewability condition is not met, the system may not proceed to a next validation step of the set of viewability conditions. FIG. 4 is a flow chart of an example process 400 for determining that the presentation of the object meets a set of viewability conditions.

At 402, the system validates the visibility of the object. In some implementations, checking a visibility of the object includes receiving, from processors (e.g., a GPU or CPU) a rendering confirmation that the object is rendered into the computing environment. For example, a gaming engine can provide instructions to the processors to render the object in the virtual environment. A rendered object can be outside a viewport that is visible by a user. For example, the rendered object can be within the computing environment but outside a field of view of the user. In another example, the rendered object can be outside the viewport of the user but can appear as a shadow within the field of view of the user. A rendered object can be within a viewport that is visible by the user. In instances where the system determines that the object is not visible in the viewport, the system determines that the object does not meet the viewability condition(s).

At 404, the system determines that a viewing angle of the object meets a threshold angle criterion. The viewing angle can be determined as an angle from a surface normal of the object to a viewpoint of the user, e.g., normal 216 in FIG. 2. For example, the object can be a two-dimensional display in the virtual computing environment, where a normal is defined from the two-dimensional surface. In some implementations, the viewing angle is compared to a threshold angle criterion, e.g., a threshold viewing angle or threshold range of viewing angles, where a viewing angle that exceeds the threshold viewing angle or is outside the threshold range of viewing angles is determined by the system to be unviewable. For example, a viewing angle can be set by a standard, e.g., an Interactive Advertising Bureau (IAB) standard, to be unviewable when greater than 55 degrees. In instances where the system determines that the viewing angle of the object does not meet the threshold angle criterion, the system determines that the object does not meet the viewability condition(s).

At 406, the system determines if the object is fully or partially onscreen. In some implementations, determining if the object is onscreen, e.g., within a field of view of the user, includes determining that pixels included in the rendered object have respective coordinates that coincide with a field of view of the user within the computing environment. For example, the system can map the world coordinates of the object to coordinates of a viewport to determine if the coordinates of the object are within the boundaries of the viewport. In instances where the system determines that the object is not onscreen, the system determines that the object does not meet the viewability condition(s). In instances where the system determines that the object is partially onscreen, the system may further determine that the portion of the object determined to be onscreen does not meet a minimum threshold for the object to be considered viewable.

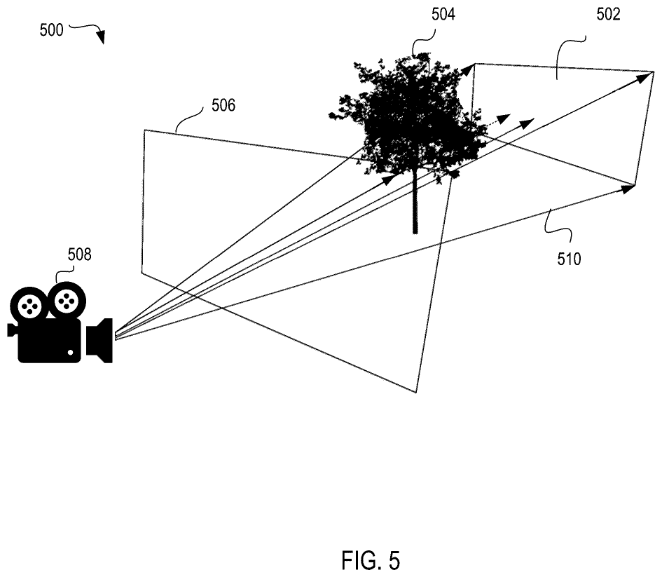

At 408, the system determines if one or more features of the object within the field of view of the user are occluded by one or more other objects located between a viewpoint of the user and the object, such that the one or more other objects occlude the user's view of the object. In some implementations, as part of the determination of whether one or more other objects occlude the user's view of the object, the system can determine if the one or more other objects meet a transparency threshold. For example, if the one or more other objects are sufficiently transparent, as indicated by meeting the transparency threshold, the one or more other objects may not be considered to occlude the features of the object. In some implementations, determining if one or more other objects occlude the user's view of the object includes using ray casting techniques, for example, as described in further detail with reference to FIG. 5.

As depicted in example operating environment 500 of FIG. 5, an object 502 can be occluded by another object 504 within a viewport 506 of a user 508, e.g., depicted in FIG. 5 as a camera. In some implementations, ray casts, e.g., ray cast 510, can be initiated from a viewpoint of the user 508 to points on the object 502. For example, ray casts can be initiated from a viewport of the user to points on the object, where the points of the object can be the corners and/or edges of the object and a center feature (e.g., center point) of the object. In instances in which the ray cast is intercepted by another object, the system can recursively initiate another ray cast from the other object towards the points on the object. In some implementations, ray casts can be alternatively (or additionally) initiated from points on the object 502 to a viewpoint of the user 508. For example, ray casts can be initiated from points on the object to a viewport of the user, where the points of the object can be the corners and/or edges of the object and a center feature (e.g., center point) of the object. In instances in which the ray cast is intercepted by another object, the system can recursively initiate another ray cast from the other object towards the viewport of the user.

In instances where the system determines that one or more other objects are located between the object and the viewport of the user, the system can check transparency values of the one or more occluding objects. For example, the system can check RGBA values and/or physical attributes of the one or more objects determined to be between the viewport of the user and the object. The system can determine a threshold transparency is met when the one or more objects are determined to be transparent based on the transparency values of the one or more objects. In instances where the transparency threshold is met for the one or more occluding objects located between the viewpoint of the user and a feature of the object, the system can determine that the feature is not occluded. In some implementations, the system can determine that an object is occluded if at least one feature of the object, e.g., two or more features of the object, are occluded. A feature of the object can be, for example, points, areas, corners, edges, or the like of the object. For example, the system can determine that the object is occluded if at least one corner or edge of the object is occluded. In some implementations, the system can determine that the object is occluded if a centrally located feature, e.g., a center point, of the object is occluded. In instances where the system determines that the one or more features of the object within the field of view of the user are occluded, the system determines that the object does not meet the viewability condition(s).

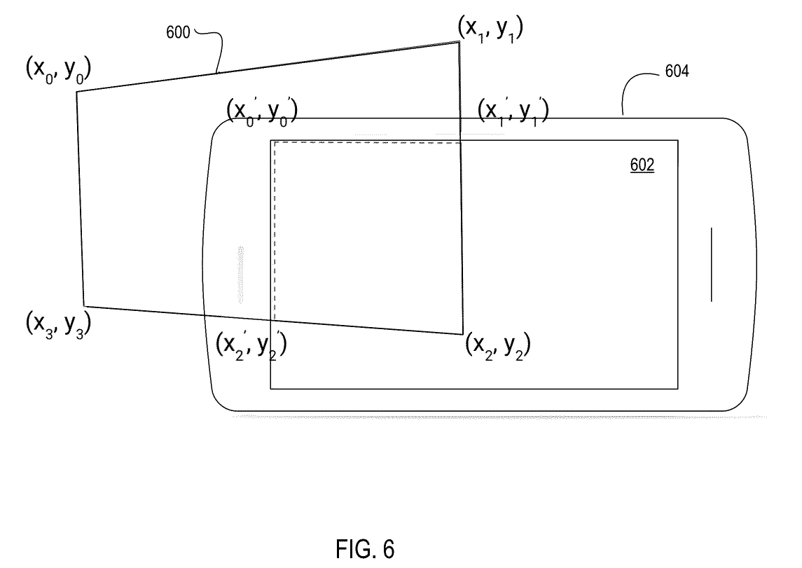

Referring to FIG. 4, at 410, the system validates a dimensionality of the object meets a threshold dimensionality. In some implementations, the system validates a threshold dimensionality by determining that a pixel ratio (e.g., percentage of) pixels included in the object compared to onscreen pixels (e.g., pixels of the viewport) meets a threshold value. For example, a threshold pixel percentage of the object pixels can be about 1.5% of the onscreen pixels, where an object having a number of objects pixels that is less than about 1.5% of the number of onscreen pixels does not meet the threshold dimensionality. For example, the system can validate a dimensionality of the object using a polygon-based calculation where an area of a polygon is calculated using equation (1) for (i) the area of the object that is onscreen (e.g., within the viewport) and (ii) a complete area of the object by using the corner vertices of the viewport. An example of an object 600 as viewed through a viewport 602 of a client device 604 is depicted in FIG. 6. The system can normalize the viewport space, e.g., where a bottom left corner is (0,0) and a top right corner is (1,1). Equation (1) yields a percent of the object area to the viewport area.

$$A ( poly ) = \vert ( {x}_{0} * {y}_{1} - {x}_{1} * {y}_{0} ) + ( {x}_{1} * {y}_{2} - {x}_{2} * {y}_{1} ) + … + ( {x}_{n} * {y}_{0} - {x}_{0} * {y}_{n} ) \vert \div 2 \qquad ( 1 )$$

where (xₙ, yₙ) are respective coordinates of the n-vertices of the polygon.

In some implementations, the system validates a threshold dimensionality by determining a number of object pixels that are onscreen pixels. For example, a threshold number of object pixels can be at least about 50% of the object pixels are onscreen pixels. In other words, at least about half of the object pixels are rendered within the viewport of the user. In instances where the system determines that the dimensionality of the object does not meet the threshold dimensionality, the system determines that the object does not meet the viewability condition(s). For example, the system can validate a dimensionality of the object using a polygon-based calculation where an area of a polygon is calculated using equation (1) where the object coordinates are constrained to viewport boundaries and the area of the object visible on the screen is calculated. Dividing this value by the unconstrained area of the object yields a percentage of the object that is visible in the viewport.

At 412, the system determines that an average luminance of the object meets a threshold luminance. In some implementations, the system determines the average luminance of the object by calculating an average luminance of the pixels included in the object and converting the average luminance value to a representative value. For example, the average luminance can be a mean, median, mode, or central tendency of luminance of the pixels included in the object. Equation (2) is one example that can be used to calculate a luminance (e.g., lumen) per pixel:

$$Pixel lumen = 0.299 * R + 0.587 * G + 0.114 * B \qquad ( 2 )$$

where R, G, B are the red, green, and blue components of the pixels. For example, a representative value for the average luminance value can be a hex value. In some implementations, the system determines that the average luminance value of the object meets a threshold luminance by comparing the representative value to threshold luminance value(s). In another example, the representative value for the average luminance of the object can be compared to a threshold brightness value and/or a threshold darkness value. In another example, the representative value can be compared to a range of luminance values. In instances where the representative value does not meet the threshold luminance values, the system can determine that the object does not meet the viewability condition(s).

At 414, the system determines that the two-dimensional projection of the object matches a reference version of the object based on a comparison of an average color of features of the reference version of the object and the average color of the features in the two-dimensional projection of the object. For example, a reference version of the object can be obtained from the content distribution system 152, e.g., in a content database 168.

In some implementations, the steps described with references are performed by processor(s). The processor(s) can be, for example, a GPU, CPU, or TPU. At times, one or more of the calculations are selectively performed by a processor based on, for example, a speed of calculation, available processing power, a type of calculation, or the like. In some implementations, processes can be performed in parallel by two or more processors. In some implementations, determining pixel-based viewability conditions and/or classifying a presentation of the object is performed by a GPU. In some implementations, calculations requiring less than a threshold compute are performed on a CPU and calculations requiring more than the threshold compute are performed on a GPU.

In some implementations, the operations described with reference to FIGS. 3 and 4 are performed to provide for an ascending computational complexity. For example, the object viewability pipeline can initiate with step 302 of FIG. 3, sequentially performing processes 402, 404, 406, 408, 410, and 412 in FIG. 4. Step 414 of FIG. 4 can follow, where the operations of step 414 are described in further detail with reference to steps 304, 306, 308, and 310/318 of FIG. 3. Following the classification in the steps 310/318, the system can perform additional steps 312, 314, and 316 or steps 320, 322, and 324, respectively. Of course, the order of operations performed can vary.

In some implementations, some or all of the operations described with reference to FIGS. 3 and 4 can be performed iteratively to continue checking a viewability of an object for a duration that the object is rendered in the virtual environment.

In some implementations, the operations described with reference to FIGS. 3 and 4 can be utilized by the system to determine object viewability of multiple (e.g., two or more) objects rendered within the virtual environment.

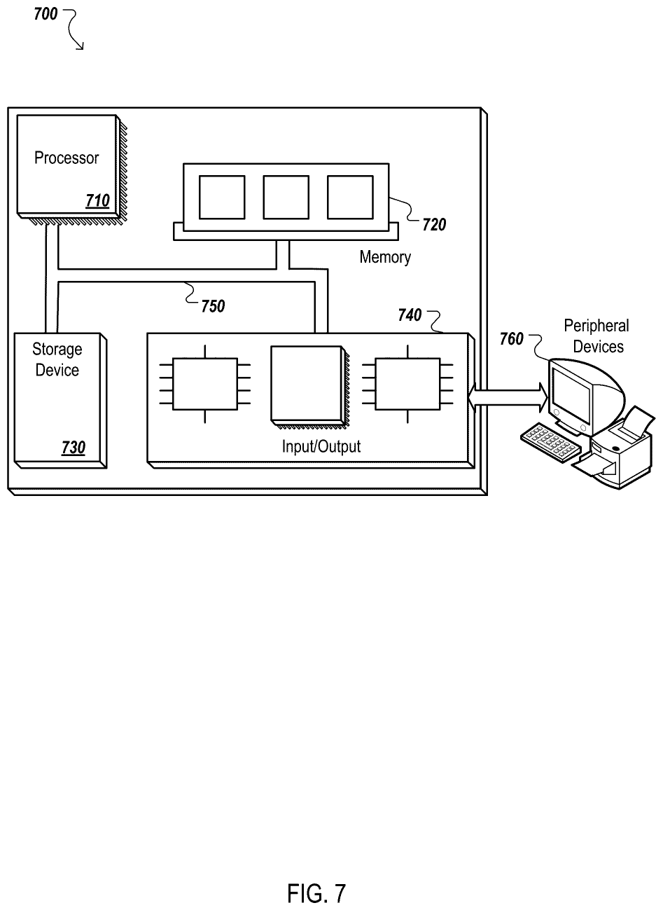

FIG. 7 is a block diagram of an example computer system 700 that can be used to perform operations described above. The system 700 includes a processor 710, a memory 720, a storage device 730, and an input/output device 740. Each of the components 710, 720, 730, and 740 can be interconnected, for example, using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730.

The memory 720 stores information within the system 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 can include, for example, a hard disk device, an optical disk device, a storage device that is shared over a network by multiple computing devices (e.g., a cloud storage device), or some other large capacity storage device.

The input/output device 740 provides input/output operations for the system 700. In one implementation, the input/output device 740 can include one or more of a network interface device, e.g., an Ethernet card, a serial communication device, e.g., and RS-232 port, and/or a wireless interface device, e.g., and 802.11 card. In another implementation, the input/output device can include driver devices configured to receive input data and send output data to peripheral devices 760, e.g., keyboard, printer and display devices. Other implementations, however, can also be used, such as mobile computing devices, mobile communication devices, set-top box television client devices, etc.

Although an example processing system has been described in FIG. 7, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document may, but need not, correspond to a file. A document may be stored in a portion of a file that holds other documents, in a single file dedicated to the document in question, or in multiple coordinated files.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

The data processing apparatus can also take the form of a gaming device. A gaming device is a device that enables a user to engage in gaming applications, for example, in which the user has control over one or more characters, avatars, or other rendered content presented in the gaming application. A gaming device typically includes a computer processor, a hardware memory device, and a controller interface (either physical or visually rendered in a display) that enables user control over content rendered by the gaming application. The gaming device can store and execute the gaming application locally or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method for determining viewability of an object by a user in a virtual environment, the method comprising:
determining that a presentation of the object within the virtual environment meets a set of viewability conditions;
capturing a two-dimensional projection of the object as presented in the virtual environment;
determining that the two-dimensional projection of the object matches a reference version of the object based on a comparison of an average color of features of the reference version of the object and the average color of the features in the two-dimensional projection of the object; and
classifying presentation of the object in the virtual environment based on whether the two-dimensional projection of the object matches the reference version of the object, including:
in response to determining that the two-dimensional projection of the object matches the reference version of the object, classifying the presentation of the object within the virtual environment as a viewable rendering of the object; and
in response to determining that the two-dimensional projection of the object does not match the reference version of the object classifying the presentation of the object within the virtual environment as a non-viewable rendering of the object.

2. The method of claim 1, wherein the set of viewability conditions comprises:
validating, from one or more processors, a rendering confirmation for the object within the virtual environment.

3. The method of claim 2, wherein the set of viewability conditions comprises:
determining a viewing angle of the object within a field of view of the user in the virtual environment meets a threshold angle criterion with respect to a surface normal of the object in the virtual environment with respect to the field of view of the user.

4. The method of claim 3, wherein the set of viewability conditions comprises:
determining that object pixels comprising the object comprise coordinates coinciding with the field of view of the user within the virtual environment.

5. The method of claim 4, wherein the set of viewability conditions comprises:
determining that one or more features of the object within the field of view of the user are not occluded by one or more other objects.

6. The method of claim 5, wherein determining that the one or more features of the object within the field of view of the user are not occluded by one or more other objects comprises determining a transparency threshold is met for the one or more other objects determined to be located between the field of view of the user and the one or more features of the object.

7. The method of claim 6, wherein the one or more features of the object comprise at least one corner feature of the object and a center feature of the object.

8. The method of claim 4, wherein the set of viewability conditions comprises:
validating a dimensionality of the object meets a threshold dimensionality comprising:
determining a pixel ratio of the object pixels to on-screen pixels meets a threshold value; and
determining a threshold number of object pixels comprise onscreen pixels.

9. The method of claim 1, wherein the set of viewability conditions comprises:
determining an average luminance of the object meets a threshold luminance.

10. The method of claim 9, wherein determining the average luminance of the object meets the threshold luminance comprises:
calculating an average luminance of pixels including the object;
converting the average luminance to a representative value; and
comparing the representative value to a threshold luminance value.

11. The method of claim 1, wherein classifying presentation of the object in the virtual environment further comprises:
in response to classifying the presentation of the object within the virtual environment as the viewable rendering of the object, incrementing a count of viewability of the object;
determining that a number of sequential incrementations of the count of viewability of the object meets a threshold viewability count; and
registering the presentation of the object.

12. The method of claim 1, wherein classifying presentation of the object in the virtual environment further comprises:
in response to classifying the presentation of the object within the virtual environment as a non-viewable rendering of the object, incrementing a count of non-viewability of the object;
determining that a number of sequential incrementations of the count of non-viewability meets a threshold non-viewability count; and
providing an alert regarding the non-viewability of the object.

13. The method of claim 1, wherein determining that the two-dimensional projection of the object matches the reference version of the object comprises:
computing a hash of the two-dimensional projection; and
comparing the hash of the two-dimensional projection to the hash of the reference version of the object.

14. The method of claim 13, wherein computing the hash of the two-dimensional projection and of the reference version of the object comprises computing an average hash comprising:
computing an average color value of at least a portion of the two-dimensional projection;
encoding each pixel of the two-dimensional projection based on whether a color value of the pixel is at least the average color value;
creating a bit string based on the encoded pixels; and
converting the bit string to a hex value.

15. The method of claim 14, wherein determining that the two-dimensional projection of the object matches a reference version of the object comprises determining a difference between the hex value and a reference hex value representing the reference version of the object.

16. The method of claim 12, wherein determining that the two-dimensional projection of the object matches a reference version of the object comprises:
identifying locations of a set of edges in the reference version of the object;
searching for the locations of the set of edges in the two-dimensional projection; and
comparing an average color of pixels of the locations of the edges in the two-dimensional projection to the average color of pixels of the locations of the edges in the reference version of the object.

17. One or more non-transitory computer storage media encoded with computer program instructions that when executed by one or more computers cause the one or more computers to perform operations comprising:
determining that a presentation of an object within a virtual environment meets a set of viewability conditions;
capturing a two-dimensional projection of the object as presented in the virtual environment;
determining that the two-dimensional projection of the object matches a reference version of the object based on a comparison of an average color of features of the reference version of the object and the average color of the features in the two-dimensional projection of the object; and
classifying presentation of the object in the virtual environment based on whether the two-dimensional projection of the object matches the reference version of the object, including:
in response to determining that the two-dimensional projection of the object matches the reference version of the object, classifying the presentation of the object within the virtual environment as a viewable rendering of the object; and
in response to determining that the two-dimensional projection of the object does not match the reference version of the object classifying the presentation of the object within the virtual environment as a non-viewable rendering of the object.

18. A system comprising:
one or more computers and one or more storage devices on which are stored instructions that are operable, when executed by the one or more computers, to cause the one or more computers to perform operations comprising:
determining that a presentation of an object within a virtual environment meets a set of viewability conditions;
capturing a two-dimensional projection of the object as presented in the virtual environment;
determining that the two-dimensional projection of the object matches a reference version of the object based on a comparison of an average color of features of the reference version of the object and the average color of the features in the two-dimensional projection of the object; and
classifying presentation of the object in the virtual environment based on whether the two-dimensional projection of the object matches the reference version of the object, including:
in response to determining that the two-dimensional projection of the object matches the reference version of the object, classifying the presentation of the object within the virtual environment as a viewable rendering of the object; and
in response to determining that the two-dimensional projection of the object does not match the reference version of the object classifying the presentation of the object within the virtual environment as a non-viewable rendering of the object.
